(19) United States
(12) Patent Application Publication
(10) Pub. No.: US 2023/0301478 A1
(43) Pub. Date: Sep. 28, 2023

(54) Handheld Vacuum Cleaner With Removable Filter

(71) Applicant: SEB S.A., Ecully (FR)

(72) Inventor: Bertrand Escalettes, Vernon (FR)

(73) Assignee: SEB S.A., Ecully (FR)

(21) Appl. No.: 18/020,782

(22) PCT Filed: Aug. 3, 2021
(86) PCT No.: PCT/EP2021/071615

§ 371 Date: Feb. 10, 2023

(30) Foreign Application Priority Data
Aug. 11, 2020 (FR) FR2008438

(51) Int. Cl. A47L 9/20; A47L 9/12; A47L 9/16; A47L 5/24; B01D 46/24; B01D 46/52; B01D 46/00

(52) U.S. Cl. CPC A47L 9/20; A47L 9/127; A47L 9/1666; A47L 5/24; A47L 9/1683; B01D 46/2403; B01D 46/521; B01D 46/0005; B01D 46/0043; B01D 2273/30; B01D 2279/55

(57) ABSTRACT

A handheld vacuum cleaner (1) comprising a vacuum cleaner housing (2), a handle (3) connected to the vacuum cleaner housing (2), an intake head (4) through which outside air can be drawn in by the handheld vacuum cleaner (1), at least one exhaust port (5) through which the cleaned air can exit the handheld vacuum cleaner (1), an airflow circuit (6) that extends between the intake head (4) and the exhaust port (5), a suction unit (7) fitted on the airflow circuit (6), the suction unit (7) comprising an electric motor (7.1) and a fan (7.2) coupled to the electric motor (7.1) to generate an air flow in the airflow circuit (6) from the intake head (4) to the exhaust port (5), a waste separation device (8) fitted on the airflow circuit (6) upstream of the suction unit (7) and through which the air flow generated by the fan (7.2) passes when the handheld vacuum cleaner (1) is being operated, a removable tank (9) for receiving the waste separated by the waste separation device (8) and which is removably attached to the vacuum cleaner housing (2), a removable filter (14) arranged in the airflow circuit (6), the removable filter (14) being housed in a filter chamber (15) of the handheld vacuum cleaner (1), the filter chamber (15) being formed at least in part in the vacuum cleaner housing (2) and being arranged at least in part between the suction unit (7) and a wall of the vacuum cleaner housing (2). The filter chamber (15) comprises an access opening (15.1) to the removable filter (14) [sic] for accessing the removable filter (14) when the removable tank (9) has been detached from the vacuum cleaner housing (2).

### TECHNICAL FIELD

The present invention relates to the field of vacuum cleaners for vacuuming dust and small particle size waste present on a surface to be cleaned, which may for example be tile, parquet, laminate, carpet or a rug.

### STATE OF THE ART

A vacuum cleaner, and more particularly a handheld vacuum cleaner, is known to comprise:
a vacuum cleaner housing,
a handle connected to the vacuum cleaner housing,
an intake head through which outside air can be drawn in by the handheld vacuum cleaner,
at least one exhaust port through which the cleaned air can exit the handheld vacuum cleaner,
an airflow circuit that extends between the intake head and the exhaust port,
a suction unit fitted on the airflow circuit, the suction unit comprising an electric motor and a fan to generate an air flow in the airflow circuit from the intake head to the exhaust port,
a device for separating dust and waste, hereinafter referred to as waste, fitted on the airflow circuit upstream of the suction unit and through which an air flow generated by the fan passes when the vacuum cleaner is being operated,
a removable tank for receiving the waste separated by the separation device and which is removably attached to the vacuum cleaner housing, the vacuum cleaner housing and the removable tank forming a separation chamber in which the separation device is fitted,

“Waste separation device” refers to a separation device, for example a filtration device using at least one filter medium or a cyclone device using at least one cyclone, which is capable of separating waste and/or dust from the intake air stream.

Conventionally, in addition to the waste separation device, the airflow circuit may be equipped with one or more dust filters arranged downstream and/or upstream of the suction unit to protect the suction unit and/or to prevent dust-laden air from escaping from the vacuum cleaner.

Over time, this type of filter becomes clogged in particular due to the dust accumulated on the upstream surfaces of the filter. The filter must then be removed for cleaning.

This type of filter is therefore usually removable.

U.S. Ser. No. 10/631,698 describes a handheld vacuum cleaner comprising an annular filter unit which also includes an annular filter. The filter unit can be detached and removed through the top of the unit. The annular filter is arranged in a filter space formed in the filter unit and can be removed from the filter unit for cleaning after disassembling a cover on the filter unit.

In practice, cleaning this removable filter is complicated and requires several manual operations to remove the filter itself.

### SUMMARY OF THE INVENTION

The present invention aims to remedy all or part of the aforementioned disadvantages.

The technical problem behind the invention is to provide a handheld vacuum cleaner with a dust filter that is separate from the waste separation device and that can be easily removed from the vacuum cleaner for cleaning.

To this end, the present invention relates to a handheld vacuum cleaner comprising,
a vacuum cleaner housing,
a handle connected to the vacuum cleaner housing,
an intake head through which outside air can be drawn in by the handheld vacuum cleaner,
at least one exhaust port through which the cleaned air can exit the handheld vacuum cleaner,
an airflow circuit that extends between the intake head and the exhaust port,
a suction unit fitted on the airflow circuit, the suction unit comprising an electric motor and a fan coupled to the electric motor to generate an air flow in the airflow circuit from the intake head to the exhaust port,
a waste separation device fitted on the airflow circuit upstream of the suction unit and through which the air flow generated by the fan passes when the handheld vacuum cleaner is being operated,
a removable tank for receiving the waste separated by the waste separation device and which is removably attached to the vacuum cleaner housing,
a removable filter arranged in the airflow circuit, the removable filter being housed in a filter chamber of the handheld vacuum cleaner, the filter chamber being formed at least in part in the vacuum cleaner housing and being arranged at least in part between the suction unit and a wall of the vacuum cleaner housing.

The filter chamber comprises an access opening for accessing the removable filter that is formed in the handheld vacuum cleaner such that the removable filter can be accessed when the removable tank has been detached from the vacuum cleaner housing. When the removable tank is attached to the vacuum cleaner housing, the removable tank is arranged relative to the vacuum cleaner housing such that it prevents access to the removable filter through the access opening.

According to the invention, the removable filter can be accessed through the access opening and can be removed through the access opening when the removable tank has been detached from the vacuum cleaner housing and the removable filter cannot be accessed by the user when the removable tank is attached to the vacuum cleaner housing.

Such a configuration makes it easy to remove the removable filter after removing the removable tank. Indeed, after removing the removable tank, for example to remove the waste accumulated in the removable tank, the removable filter can be directly accessed without having to open a lid or disassemble an intermediate part.

The vacuum cleaner may also have one or more of the following features, alone or in combination.

The access opening is formed in the vacuum cleaner housing and is facing the removable tank when the removable tank is attached to the vacuum cleaner housing.

The intake head forms a front part of the handheld vacuum cleaner. The access opening and the removable tank are arranged relative to each other such that the removable filter can be removed from the front of the handheld vacuum cleaner through the access opening when the removable tank has been detached from the vacuum cleaner housing.

This front removal of the removable filter provides the user with an ergonomic position in which to remove the removable filter. In fact, handheld vacuum cleaners are generally held by the rear using the handle and with a first hand. The ability to remove the removable filter from the front allows the user to use his or her second hand to grasp and remove the removable filter from the front. In this phase of removing the removable filter, the two hands are positioned opposite each other and exert opposing pulling forces, making it easier for the first hand to grip the handheld vacuum cleaner and the second hand to grip the removable filter, while also making it easier to remove the removable filter from the filter chamber.

The separation device is housed in the removable tank such that it can be separated from the vacuum cleaner housing along with the removable tank.

This construction makes it possible to remove the separation device with the removable tank to make it easier to remove and clean the separation device.

The electric motor comprises an output shaft with a rotary axis. Advantageously, the separation device, the fan and the electric motor are essentially aligned.

Such an in-line construction is very compact and results in a handheld vacuum cleaner that is limited in size. Moreover, having the separation device, the fan and the electric motor aligned, in other words, in line, makes it possible to optimize the trajectories of the ducts in the airflow circuit to reduce the pressure losses of the air flow circulating in the airflow circuit.

Preferably, the separation device, the fan and the electric motor are aligned with the rotary axis of the electric motor output shaft. The access opening is advantageously arranged in the vacuum cleaner housing between the waste separation device and the electric motor in a direction parallel to the rotary axis.

Advantageously, when the removable tank is attached to the vacuum cleaner housing, it rests against the filter housing via a connection interface on the vacuum cleaner housing.

Advantageously, the connection interface defines an interface plane; the access opening is formed on the interface plane or is offset relative to the interface plane in a direction parallel to the rotary axis.

Advantageously, the access opening is offset relative to the interface plane toward the interior of the vacuum cleaner housing.

Preferably the access opening is formed in an offset plane that is offset relative to the interface plane toward the interior of the vacuum cleaner housing. The offset plane is offset by less than one centimeter relative to the interface plane, measured along the direction of the rotary axis.

The connection interface comprises a contact surface against which the removable tank rests when it is attached to the vacuum cleaner housing. The contact surface is substantially annular in shape. The filter chamber and the access opening are radially arranged in the vacuum cleaner housing inside the contact surface.

This construction makes it possible to easily arrange the access opening so as to make the filter chamber inaccessible to the user when the removable tank is attached to the vacuum cleaner housing and to make it accessible when the removable tank has been detached from the vacuum cleaner housing. In addition, a substantially annular contact surface can be easily achieved and makes it possible to obtain an evenly distributed contact pressure from the removable tank on the vacuum cleaner housing. Evenly distributed contact pressure allows for more efficient management of the tightness between the removable tank and the contact surface.

The removable tank may be attached to the vacuum cleaner housing in various ways, in particular by a snap-on fitting with at least one notch and a locking latch, by a bayonet-type fitting, by a screw-on fitting or by any other means known to the person skilled in the art.

Advantageously, the filter chamber is entirely contained within the vacuum cleaner housing and is arranged between the suction unit and a wall of the vacuum cleaner housing.

This configuration avoids having to reduce the internal volume of the removable tank to allow for optimal waste storage capacity in the removable tank. Moreover, arranging the filter chamber between the suction unit and a wall of the vacuum cleaner housing enables a compact internal arrangement of the housing. Furthermore, when the access opening is offset relative to the interface plane toward the interior of the vacuum cleaner housing, the removable filter does not protrude from the vacuum cleaner housing when the removable tank has been detached. This configuration thus prevents the removable filter from interfering with or snagging the removable tank when the tank is detached from the vacuum cleaner housing.

Advantageously, the removable filter and the filter chamber extend at least partially around the suction unit.

According to the invention, the removable filter and the filter chamber do not necessarily extend all the way around the suction unit to allow, for example, in certain handheld vacuum cleaner configurations, for through-channels for wires or air ducts that cannot pass through the filter chamber. The removable filter and the filter chamber may, for example, have a “C” shape that extends around the suction unit.

Advantageously, the removable filter and the filter chamber are generally annular in shape and extend around the suction unit, preferably around the electric motor of the suction unit.

Such a generally annular shape is closed and therefore substantially “O”-shaped. This shape makes it possible to optimize the internal volume of the filter chamber around the suction unit to obtain a compact handheld vacuum cleaner. If, for example, through-channels for electrical wiring or air ducts are required in the vicinity of the filter chamber, they can be arranged around the filter chamber, for example in slots or grooves that only slightly alter the annular shape of the filter chamber.

Advantageously, the electric motor comprises an output shaft with a rotary axis, in which the output shaft is coupled to the fan and in which the removable filter, the filter chamber and the access opening are annular in shape and are centered on the rotary axis.

This concentric arrangement around the rotary axis makes it possible to optimize the arrangement of the filter chamber around the suction unit and thus to reduce its size for improved compactness of the handheld vacuum cleaner.

Advantageously, the waste separation device is a cyclone separator in which the main axis is coaxial with the rotary axis of the electric motor output shaft.

Advantageously, the removable filter is arranged in the airflow circuit between the suction unit and the exhaust port. In other words, the removable filter and the filter chamber are arranged on the portion of the airflow circuit that is downstream relative to the suction unit and is therefore positioned at the exhaust end relative to the suction unit.

Although the invention is also designed to receive a removable filter and a filter chamber that can be arranged in the upstream portion of the airflow circuit, that is, upstream of the suction unit, the formation of the filter chamber between the suction unit and a wall of the vacuum cleaner housing is better adapted to a suction chamber and a removable filter that are arranged in the downstream portion of the airflow circuit. In fact, a configuration in which the filter chamber is a downstream chamber makes it possible to better optimize the airflow circuit, in terms of pressure losses, noise reduction and overall dimensions, when the suction chamber and the removable filter are arranged in the downstream portion of the airflow circuit.

Advantageously the handheld vacuum cleaner comprises a suction unit housing that at least partially surrounds the suction unit.

Advantageously, the removable filter and the filter chamber are annular in shape and the filter chamber extends between a wall of the suction unit casing and the housing of the appliance.

Advantageously, the suction unit casing comprises a first wall and a second wall that are annularly shaped, for example tubular or frustoconical, the first annular wall at least partially surrounding the suction unit and the second annular wall at least partially surrounding the first annular wall, the second annular wall being concentric with the first annular wall and being formed apart from the first annular wall to define an annular space between the first annular wall and the second annular wall, the annular space forming the filter chamber in which the removable filter is housed.

This arrangement makes it possible to optimize the construction of the filter chamber, which is formed in an annular cavity of the suction unit casing. The suction unit casing thus makes it possible to achieve two features: a housing for the suction unit and a filter chamber. The suction unit casing is preferably manufactured in one piece, for example by plastic injection molding, which makes it possible to easily and economically produce the suction unit casing and the filter chamber while optimizing the internal volumes around the suction unit and thus to obtain a handheld vacuum cleaner that is relatively compact and simple in its construction.

Advantageously, the second annular wall of the suction unit casing forms at least one wall of the vacuum cleaner housing. In other words, at least one outer surface of the second annular wall of the suction unit casing forms an outer surface of the handheld vacuum cleaner.

This arrangement makes it possible to achieve three features with a single part. Indeed, the suction unit casing makes it possible to create a suction unit casing, to create the filter chamber and to form a portion of the housing of the handheld vacuum cleaner. This arrangement thus makes it possible to obtain a handheld vacuum cleaner that is easier to manufacture and assemble than a conventional handheld vacuum cleaner. Moreover, it makes it possible to obtain a handheld vacuum cleaner that is lighter and more compact than a conventional vacuum cleaner.

Advantageously, the second annular wall comprises said at least one exhaust port, preferably several exhaust ports. Said at least one exhaust port forms at least one air outlet on the filter chamber.

This arrangement makes it possible to obtain a handheld vacuum cleaner that is even easier to manufacture by eliminating the ducts between the filter chamber and the outer wall of the vacuum cleaner housing.

In an alternative embodiment, also covered by the claimed invention, the second annular wall of the suction unit casing is separate from the housing and is radially positioned inside the housing.

When the second annular wall of the suction unit casing is separate from the housing and is radially positioned inside the housing, the second annular wall comprises at least one outlet port for bringing the downstream portion of the filter chamber into aeraulic communication with said at least one exhaust port.

Advantageously, the first annular wall and the second annular wall are connected by at least one connecting wall that extends radially, relative to the rotary axis of the electric motor, between the first annular wall and the second annular wall.

Advantageously, the connecting wall extends to the bottom of the filter chamber, preferably on a side of the suction unit casing that is opposite the access opening.

This configuration makes it possible to optimize the internal volume of the filter chamber and makes it easier to unmold the filter unit housing when it is obtained by plastic injection molding.

Advantageously, said connecting wall is an annular, disk-shaped wall that comprises at least one air inlet on the filter chamber in aeraulic communication with an air outlet on the suction unit.

Preferably, the first annular wall has no opening on its outer side.

Advantageously, the first annular wall, the second annular wall and said at least one connecting wall are manufactured in one piece. The first annular wall, the second annular wall and said at least one connecting wall are obtained, for example, by plastic injection molding. Thus, and although it combines several features as previously described, the suction unit casing remains easy to manufacture.

Advantageously, the removable filter is annular in shape and preferably comprises a pleated filter medium that is configured in an annular shape.

An annular filter, preferably pleated, makes it possible to optimize the filtration surface and the filtration capacity while optimizing the volumes of the vacuum appliance. This is especially true when the annular filter is arranged around a suction unit that is generally cylindrical in shape.

Advantageously, the removable filter comprises annular end disks attached to the axial ends of the pleated filter medium.

Advantageously, the annular end disks are airtight.

Advantageously, a first annular end disk closes the access opening when the removable filter is placed in the filter chamber.

This configuration therefore uses an annular end disk on the filter to close the access opening, thus avoiding the need for an intermediate part to close the filter chamber. The resulting handheld vacuum cleaner has a simpler construction.

Advantageously, the first annular end disk comprises gripping means such as pull tabs or an annular grip flange projecting axially from the first end disk to enable the user to remove the removable filter more easily. Additionally, incorporating gripping means directly onto the first annular end disk further simplifies the construction of the handheld vacuum cleaner. The gripping means preferably come from plastic injection molding with the first annular end disk.

Advantageously, the first annular end disk is transparent to enable the user to visually check the degree of cleanliness or clogging of the removable filter without having to take the removable filter out of the filter housing, in order to know whether or not the removable filter needs to be cleaned.

Advantageously, the removable filter defines, in the filter chamber, an upstream portion and a downstream portion of the filter chamber.

Advantageously, the handheld vacuum cleaner comprises at least a first gasket radially positioned between the first wall and the first annular end disc. The first gasket is preferably attached to the removable filter.

Preferably, the handheld vacuum cleaner comprises a second gasket radially positioned between the second annular end disc and the second annular wall. The second gasket is preferably attached to the removable filter.

Preferably, the handheld vacuum cleaner comprises a third gasket radially positioned between the first annular end disc and the second annular wall. The third gasket is preferably attached to the removable filter.

Preferably, the handheld vacuum cleaner comprises a fourth gasket radially positioned between the second annular end disc and the first annular wall. The fourth gasket is preferably attached to the removable filter.

The first gasket and/or the third gasket on one side of the removable filter and the second gasket and/or the fourth gasket on the other side of the removable filter make it possible, with the exception of the porosities of the filter medium, to isolate the upstream portion of the filter chamber from the downstream portion.

The first gasket and the third gasket make it possible to seal the filter chamber shut at the first annular disc.

### BRIEF DESCRIPTION OF THE FIGURES

The following description highlights the features and advantages of the present invention. This description is based on illustrations, including:

FIG. 1 illustrates an overall view of a handheld vacuum cleaner according to a particular embodiment;

FIG. 2 illustrates the handheld vacuum cleaner in FIG. 1 according to a longitudinal cross-section view;

FIG. 3 illustrates the handheld vacuum cleaner in FIG. 1 according to a three-quarter front perspective view, without the removable tank and without the separator;

FIG. 4 illustrates a partial cross-section view of the rear of the handheld vacuum cleaner in FIG. 3;

FIG. 5 illustrates the handheld vacuum cleaner in FIG. 1 according to a three-quarter front perspective view, without the removable tank and without the separator, with the removable filter partially removed from the filter chamber;

FIG. 6 illustrates a partial cross-section view of the rear of the handheld vacuum cleaner in FIG. 5;

FIG. 7 illustrates the handheld vacuum cleaner in FIG. 1 according to a three-quarter front perspective view, without the removable tank and without the separator, with the removable filter completely removed from the filter chamber;

FIG. 8 illustrates a partial cross-section view of the rear of the handheld vacuum cleaner in FIG. 7;

FIG. 9 illustrates the suction unit casing of the handheld vacuum cleaner in FIG. 1 according to a three-quarter front perspective view;

FIG. 10 illustrates the suction unit casing in FIG. 1 in a longitudinal cross-section view.

### DETAILED DESCRIPTION

In the remainder of the description, the handheld vacuum cleaner is referred to as a vacuum cleaner.

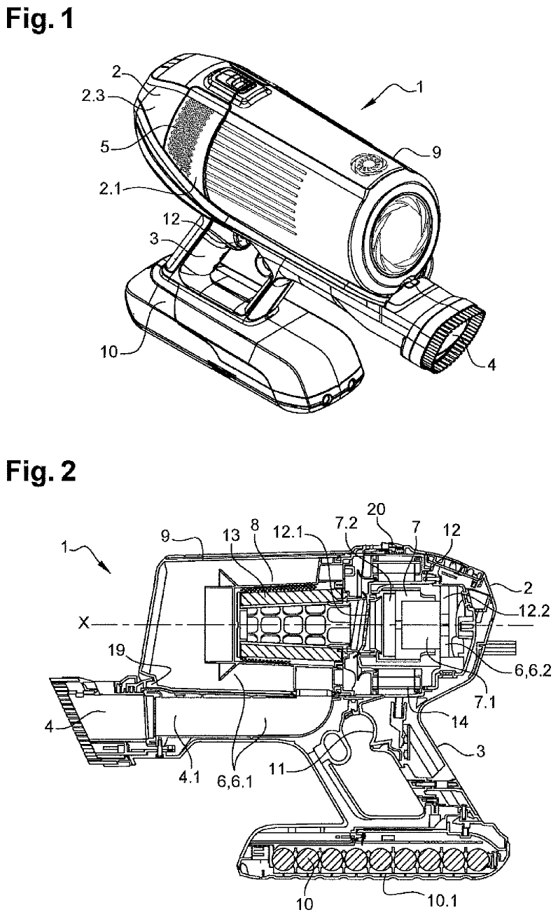

FIGS. 1 to 10 show a vacuum cleaner 1 comprising a vacuum cleaner housing 2, a handle 3 connected to the vacuum cleaner housing 2, an air intake head 4 through which outside air can be drawn in by the vacuum cleaner 1, several air exhaust ports 5 through which the cleaned air can exit the vacuum cleaner 1. The vacuum cleaner 1 further comprises an airflow circuit 6 that extends between the intake head 4 and the exhaust ports 5. The vacuum cleaner 1 comprises a suction unit 7 fitted on the airflow circuit 6. The suction unit 7 comprises an electric motor 7.1 and a fan 7.2 (shown in FIGS. 2, 4 and 6) coupled to the electric motor 7.1 to generate an air flow in the airflow circuit 6 from the intake head 4 to the exhaust ports 5. The handle 3 may be manufactured in one piece with the vacuum cleaner housing 2 or may be attached to it.

The vacuum cleaner 1 also comprises a waste separation device 8 fitted on the airflow circuit 6 upstream 6.1 of the suction unit 7. An air flow generated by the suction unit 7 passes through the waste separation device 8 when the vacuum cleaner 1 is being operated. The vacuum cleaner 1 comprises a removable tank 9, also referred to as a waste storage container, for receiving and accumulating the waste separated by the waste separation device 8 and which is removably attached to the vacuum cleaner housing 2. The waste separation device 8 is advantageously arranged in the removable tank 9. In this case, the removable tank 9 forms a separation chamber. The waste separation device 8 may be detached from the removable tank 9 to make it easier to empty the contents of the removable tank 9 when the latter has been detached from the vacuum cleaner housing 2. The air intake head 4 is connected to the separation chamber, which corresponds to the interior of the removable tank 9, by an air intake duct 4.1 (shown in FIG. 2).

The vacuum cleaner 1 preferably comprises a battery pack 10 arranged in the lower part of the vacuum cleaner 1. A bottom surface 10.1 of the battery pack 10 enables the vacuum cleaner 1 to rest on a horizontal surface when the vacuum cleaner 1 is not in use (see FIG. 2). The handle 3 extends between the battery pack 10 and the vacuum cleaner housing 2, advantageously in a rear part 13 of the vacuum cleaner.

The vacuum cleaner 1 comprises a switch 11 for activating the vacuum cleaner, which controls, in particular, the activation of the suction unit 7 when it is switched on by the user.

The electric motor 7.1 comprises an output shaft 7.3 (shown in FIGS. 2, 4, 6 and 8) with a rotary axis X. The output shaft 7.3 is coupled to the fan 7.2.

Advantageously, and as shown in FIGS. 1 to 10, the separation device 8, the fan 7.2 and the electric motor 7.1 are aligned. More specifically, the waste separation device 8, the fan 7.2 and the electric motor 7.1 are aligned and centered on the rotary axis X of the electric motor 7.1. In this configuration, the rotary axis X is a main axis of the vacuum cleaner 1.

The suction unit 7 is in a rear part 13 of the vacuum cleaner 1 and the waste separation device 8 is located in front of the suction unit 7. FIGS. 4 and 6 show the rear part 13 of the vacuum cleaner 1. In the embodiment shown in the figures, the intake head 4 of the vacuum cleaner 1 forms a front end of the handheld vacuum cleaner 1. This intake head 4 advantageously projects forward from the rest of the handheld vacuum cleaner 1, in particular relative to the removable tank 9.

The vacuum cleaner 1 further comprises a suction unit casing 12 that at least partially surrounds the suction unit 7. More specifically, the suction unit casing 12 comprises a first wall 12.3 that at least partially covers the suction unit 7.

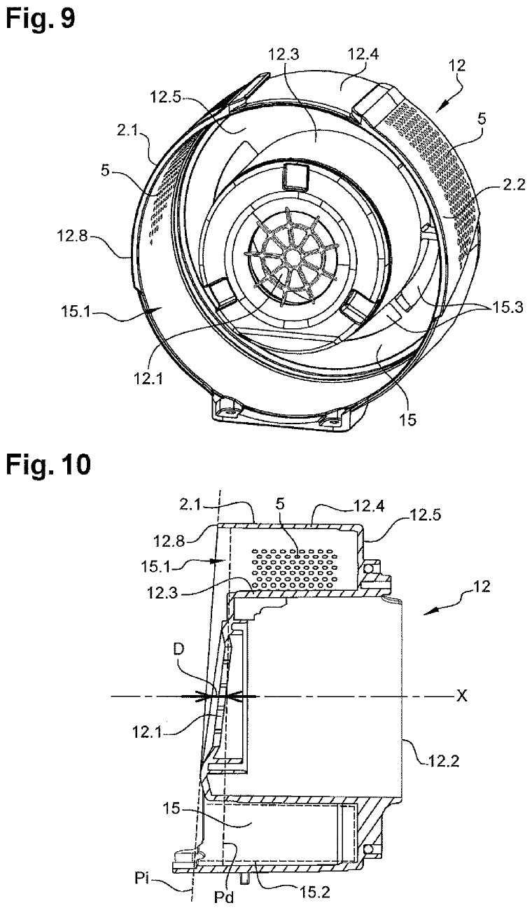

The suction unit casing 12 is visible in FIGS. 2 to 10 and more specifically in FIGS. 9 and 10. The suction unit casing 12 is used in particular to position and hold the suction unit 7 in the vacuum cleaner 1 and also to protect the suction unit 1 [sic: 7].

As shown in the figures, the suction unit 7 may comprise an intermediate casing 7.4 that is radially arranged inside the suction unit casing 12 relative to the rotary axis X of the electric motor 7.1.

The suction unit casing 12 comprises an air inlet opening 12.1 and an air outlet opening 12.2 which are in aeraulic communication with the suction unit 7 and which are arranged on either side of the suction unit 7 in the direction of the rotary axis X. The air inlet opening 12.1 communicates with an upstream part 6.1 of the airflow circuit 6 and the air outlet 12.2 communicates with a downstream part of the airflow circuit 6. In other words, the upstream part 6.1 of the airflow circuit 6 is located upstream of the suction unit 7 and extends between the intake head 4 and the suction unit 7. The downstream part 6.2 of the airflow circuit 6 is located downstream of the suction unit 7 and extends between the suction unit 7 and the exhaust ports 5.

The waste separation device 8 is arranged in the upstream part 6.1 of the airflow circuit 6.

In the embodiment shown in FIGS. 1 to 10, the separation device 8 is advantageously a cyclone separator with a main axis that is coaxial with the rotary axis X of the output shaft 7.3 of the electric motor 7.1. In an alternative embodiment not shown, and without departing from the scope of the invention, the waste separation device could be made of a filter comprising a porous filter medium to let air through and prevent waste from passing through it.

To limit the amount of dust sucked into the suction unit 7, the vacuum cleaner 1 may comprise, in addition to the waste separation device 8, an upstream filter 13 (see FIG. 2) that is arranged in the airflow circuit between the waste separation device 8 and the suction unit 7. This upstream filter 13 is preferably removable; it is frustoconical in shape and is housed in a central portion of the cyclone separator.

To limit or prevent dust from escaping from the exhaust ports 5 to the outside of the vacuum cleaner 1, the vacuum cleaner 1 comprises, in addition to the waste separation device 8, a removable downstream filter 14 that is placed in a filter chamber 15. The removable filter 14 and the filter chamber 15 are arranged downstream of the suction unit 7, more precisely they are arranged in the airflow circuit between the suction unit 7 and the exhaust ports 5. The filter chamber 15 and the removable filter 14 are arranged on the airflow circuit 6 such that an air flow generated by the suction unit 7 passes through them when the vacuum cleaner 1 is being operated.

In the embodiment shown in the figures, the filter chamber 15 and the removable filter 14 are annular in shape and extend around the suction unit 7. The filter chamber 15 and the removable filter 14 are preferably centered on the rotary axis X. Advantageously, the filter chamber 15 is entirely contained within the vacuum cleaner housing 2.

As shown in FIGS. 4, 6, 8, 9 and 10, the suction unit casing 12 comprises a second wall 12.4 that surrounds the first wall 12.3. The second wall 12.4 is formed apart from the first wall 12.3 to partially define, together with the first wall 12.3, the filter chamber 15. The filter chamber 15 extends between the first wall 12.3 and the second wall 12.4.

The first wall 12.3 and the second wall 12.4 are advantageously annular in shape coaxial to the rotary axis X of the output shaft 7.3 of the electric motor 7.1. In the embodiment shown in the figures, the first wall 12.3 and the second wall 12.4 are more specifically tubular in shape. In an alternative embodiment not shown, the first wall and second wall could also be substantially frustoconical in shape.

In another alternative embodiment not shown, the first wall and the second wall are partially annular in shape around the rotary axis of the electric motor such that the first wall and the second wall define a partially annular filter chamber around the suction unit. According to this alternative, the filter chamber could, for example, be in the shape of a ring section or the filter chamber could have a “C”-shaped cross-section (unclosed ring).

According to the embodiment shown in the figures, the first wall 12.3 and the second wall 12.4 are joined by a connecting wall 12.5. Advantageously, the connecting wall 12.5 extends radially, relative to the rotary axis X of the electric motor 7.1, between the first wall 12.3 and the second wall 12.4.

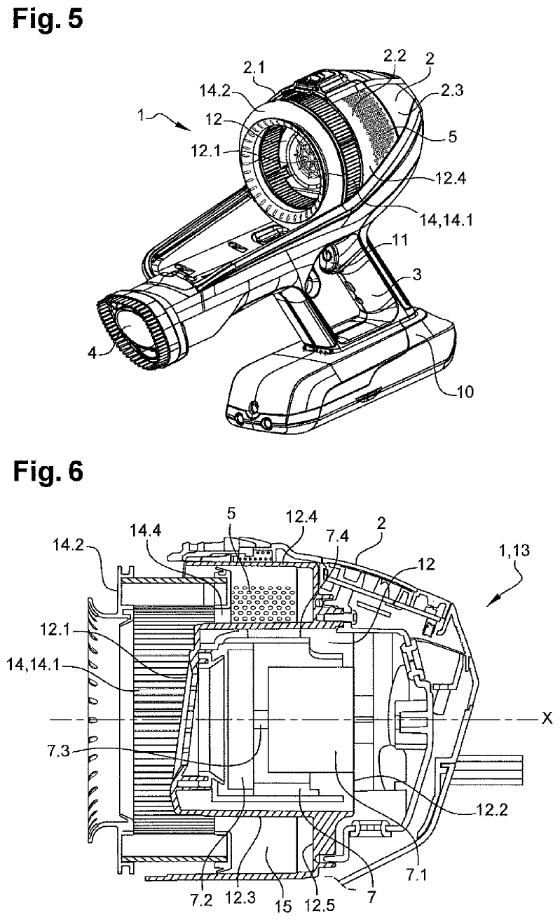

The first wall 12.3, the second wall 12.4 and the connecting wall 12.5 define the filter chamber 15, which is annular in shape and extends around the suction unit 7. The removable filter 14 is also annular in shape and fits into the annular shape of the suction chamber 15. The removable filter 14 preferably comprises a pleated filter medium 14.1 that is configured in an annular shape (see FIGS. 5, 6, 7 and 8).

As shown in FIGS. 9 and 10, the first wall 12.3, the second wall 12.4 and the connecting wall 12.5 are advantageously made in one piece, preferably in a single piece obtained by plastic injection molding.

As shown in FIGS. 9 and 10, the connecting wall 12.5 is in the form of an annular disk. In one alternative as previously described, in which the first wall and the second wall are partially annular in shape around the rotary axis of the electric motor, the connecting wall is also partially annular in shape. In this alternative embodiment, the connecting wall is in the shape of a disk section or has a substantially rectangular or trapezoidal shape or a “C” shape, for example.

In another alternative embodiment (not shown) the first wall and the second wall could be connected by connecting arms radially extending between the first wall and the second wall. According to this alternative, the first wall, the second wall and the connecting arms are advantageously made in one piece, preferably in a single piece obtained by plastic injection molding.

According to the embodiment shown in the figures, the filter chamber 15 comprises an access opening 15.1 to the removable filter 14 to enable the user to access the removable filter 14 and remove the removable filter 14 from the vacuum cleaner 1 when the removable tank 9 has been detached from the vacuum cleaner housing 2. The access opening 15.1 is formed in the vacuum cleaner housing 2 and is facing the removable tank 9 when the removable tank 9 is attached to the vacuum cleaner housing 2. The removable filter 14 is therefore made inaccessible to the user when the removable tank 9 is attached to the vacuum cleaner housing 2. More specifically, the access opening 15.1 is formed in the suction unit casing 12. The access opening 15.1 is formed on a side of the suction unit casing 12 that is opposite the connecting wall 12.5. Thus, the filter chamber 15 is defined by walls 12.3, 12.4 and 12.5 of the suction unit casing 12 which, over one half-section, for example a half-section in FIG. 10, substantially form a “U”. This U-shape is shown as a dotted line in FIG. 10 and is referenced as 15.2.

The access opening 15.1 faces the removable tank 9 when the removable tank is attached to the vacuum cleaner housing 2 such that the removable filter 14 can be removed through the access opening toward the front of the vacuum cleaner 1 when the removable tank 9 has been detached from the vacuum cleaner housing 2.

The removable filter 14 comprises a first annular end disk 14.2 attached to a first axial end 14.3 of the pleated filter medium 14.1 and a second annular end disk 14.4 attached to a second axial end 14.5 of the pleated filter medium 14.1 (see FIGS. 6 and 8).

The annular end disks 14.2 and 14.4 are airtight and are attached in an airtight manner to the axial ends 14.3 and 14.5 of the pleated filter medium 14.1.

The first annular end disk 14.2 closes the access opening 15.1 when the removable filter 14 is placed in the filter chamber 15.

The first annular end disk 14 comprises gripping means 14.6 such as pull tabs or an annular grip flange projecting axially from the first annular end disk 14.2.

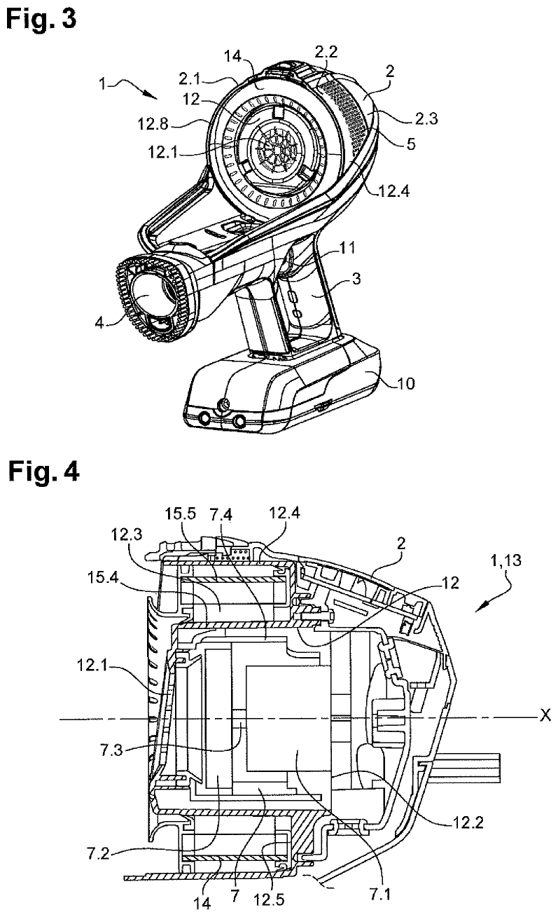

The removable filter 14 defines, in the filter chamber 15, an upstream portion 15.4 and a downstream portion 15.5 of the filter chamber 15 (see FIG. 3).

The vacuum cleaner 1 comprises a first gasket 14.7 radially positioned between the first wall 12.3 and the first annular end disc 14.2.

The handheld vacuum cleaner comprises a second gasket 14.8 radially positioned between the second annular end disc 14.4 and the second annular wall 12.4. The first gasket 14.7 and the second gasket 14.8 are preferably attached to the removable filter 14 and, for example, seated in annular grooves in the removable filter 14.

The first and second gaskets 14.7, 14.8 make it possible, with the exception of the pores of the pleated filter medium 14.1, to isolate the upstream portion 15.4 of the filter chamber 15 from the downstream portion 15.4.

The vacuum cleaner 1 may comprise a third gasket radially positioned between the first annular end disc and the second annular wall. The third gasket is preferably attached to the removable filter.

The handheld vacuum cleaner may comprise a fourth gasket radially positioned between the second annular end disc and the first annular wall. The fourth gasket is preferably attached to the removable filter.

The filter chamber 15 comprises at least one air inlet 15.3 formed on the connecting wall 12.5. As shown in FIG. 9, several air inlets 15.3 are advantageously formed in the connecting wall 12.5. The air inlets 15.3 are in aeraulic communication with the air outlet opening 12.2 and with the suction unit 7. The filter chamber 15 comprises at least one air outlet that is formed on the second wall 12.4. Advantageously, the filter chamber 15 comprises several air outlets formed on the second wall 12.4.

Advantageously and as shown in the figures, two portions of the second wall 12.4 form two walls 2.1 and 2.2 of the vacuum cleaner housing 2. The exhaust ports 5 are cut into the two portions of the second wall 12.4 forming the two walls 2.1 and 2.2 of the vacuum cleaner housing 2. Advantageously, the air outlets in the filter chamber 15 are the exhaust ports 5. The walls 2.1 and 2.2 are advantageously arranged symmetrically on both sides of the vacuum cleaner 1.

The first wall 12.3 preferably has no opening on its side and forms a substantially cylindrical or frustoconical solid surface.

The second wall 12.4 is arranged between the removable tank 9 and a rear part 2.3 of the vacuum cleaner housing 2 in a direction parallel to the rotary axis X of the electric motor 7.1.

Advantageously, when the removable tank 9 is attached to the vacuum cleaner housing, it rests against the filter housing via a connection interface 12.8 on the vacuum cleaner housing. The connection interface 12.8 defines an interface plane Pi. The access opening 15.1 is formed at the connection interface 12.8 of the vacuum cleaner housing 2 or in an offset plane Pd which is perpendicular to the rotary axis X and which is offset relative to the interface plane Pi toward the interior of the vacuum cleaner housing 2.

The offset plane Pd is offset by a distance D of less than one centimeter relative to the interface plane, measured along the direction of the rotary axis X.

The connection interface comprises a contact surface 12.8 that is substantially annular. The access opening 15.1 and the filter chamber 15 are radially arranged in the vacuum cleaner housing 2 inside the contact surface 12.8.

The removable tank 9 is reversibly attached to the vacuum cleaner housing 2. The removable tank 9 may be attached to the vacuum cleaner housing 2 in various ways, in particular by a snap-on fitting, by a bayonet-type fitting, by a screw-on fitting or, as shown for example in FIG. 1, by means of a notch 19 and a locking latch 20.

The procedure for removing the removable filter 14 from the vacuum cleaner housing 2 is explained below.

FIGS. 1 and 2 show the vacuum cleaner 1 in an operating condition. In this operating condition, the removable filter 14 is in place in the filter chamber 15 and the removable tank 9 is attached to the vacuum cleaner housing 2.

To extract the removable filter 14 and given the aforementioned operating condition, the user first detaches the removable tank 9 from the vacuum cleaner housing 2 by unlocking the locking latch 20 and disengaging the removable tank 9 from the notch 19. When the removable tank 9 has been detached and removed from the vacuum cleaner housing 2, the removable filter 14 becomes accessible through the access opening 15.1. Indeed, as shown in FIGS. 3 and 4, the first annular disk 14.2 advantageously provided with gripping means 14.6 is then visible and accessible by the user who can then grasp the removable filter 14 by the gripping means 14.6. This first intermediate step in removing the removable filter 14 is shown in FIGS. 3 and 4.

From the first intermediate step in removing the removable filter 14 shown in FIGS. 3 and 4, the user grasps the removable filter 14 by the gripping means 14.6, in this case an annular flange, to remove the removable filter 14 through the access opening 15.1. The user pulls the removable filter 14 which slides toward the front of the vacuum cleaner 1 in a direction parallel to the rotary axis X of the electric motor 7.1. More precisely, the user holds the vacuum cleaner 1 with a first hand by the handle 3 and pulls the removable filter 14 with a second hand by the gripping means 14.6 such that the user's two hands are substantially facing each other and exert opposing pulling forces. FIGS. 5 and 6 show a second intermediate step in which the removable filter 14 is partially removed from the filter chamber 15.

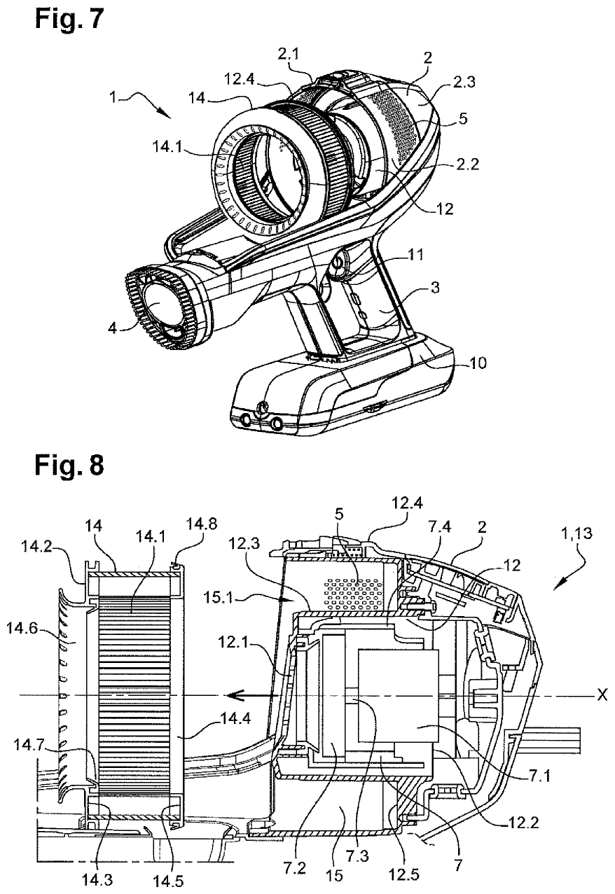

From the second intermediate step in removing the removable filter 14 shown in FIGS. 4 and 5, the user continues the movement of removing the removable filter 14 until it is completely removed. This last step of completely removing the removable filter 14 is shown in FIGS. 7 and 8.

The present invention thus allows for easy access to the removable filter 14 once the removable tank 9 has been detached from the vacuum cleaner housing 2. According to the present invention, it is therefore not necessary to remove or displace a specific additional lid or any other intermediate part to access the removable filter 14 once the removable tank 9 has been detached. As explained above, once the removable tank 9 has been detached and removed from the vacuum cleaner housing 2, the removable filter 14 is visible and accessible and can be easily removed from the vacuum cleaner housing 2 by sliding it toward the front of the vacuum cleaner 1. Moreover, and as explained above, to remove the removable filter the user has his or her hands facing each other to exert opposing pulling forces. This is a natural and ergonomic hand position for the user to remove the removable filter.

Of course, the present invention is in no way limited to the embodiment described and illustrated, since this embodiment was only provided by way of example. Changes can still be made, particularly with regard to the constitution of the various elements or by substituting technical equivalents, without departing from the scope of protection of the invention.

For example, in the embodiment shown in FIGS. 1 to 10, the access opening 15.1 facing the removable tank 9 provides access to a removable filter 14 arranged downstream of the suction unit 7. In an alternative embodiment, and without departing from the scope of the invention, the access opening 15.1 could provide access to a removable filter and to a filter chamber arranged upstream of the suction unit 7.

In the embodiment shown in FIGS. 1 to 10, the filter chamber 15 is entirely contained within the vacuum cleaner housing 2. In an alternative embodiment, and without departing from the scope of the invention, the filter chamber could be formed partly in the vacuum cleaner housing and partly in the removable tank such that when the removable tank is removed the removable filter protrudes axially beyond the vacuum cleaner housing.

In the embodiment shown in FIGS. 1 to 10, the filter chamber 15 is formed in a suction unit casing 7. In an alternative embodiment, and without departing from the scope of the invention, the filter chamber could be formed in a part of the vacuum cleaner other than the suction unit casing or between different parts of the vacuum cleaner.

1. A handheld vacuum cleaner (1) comprising,
a vacuum cleaner housing (2),
a handle (3) connected to the vacuum cleaner housing (2),
an intake head (4) through which outside air can be drawn in by the handheld vacuum cleaner (1),
at least one exhaust port (5) through which the cleaned air can exit the handheld vacuum cleaner (1),
an airflow circuit (6) that extends between the intake head (4) and the exhaust port (5),
a suction unit (7) fitted on the airflow circuit (6), the suction unit (7) comprising an electric motor (7.1) and a fan (7.2) coupled to the electric motor (7.1) to generate an air flow in the airflow circuit (6) from the intake head (4) to the exhaust port (5),
a waste separation device (8) fitted on the airflow circuit (6) upstream of the suction unit (7) and through which the air flow generated by the fan (7.2) passes when the handheld vacuum cleaner (1) is being operated,
a removable tank (9) for receiving the waste separated by the waste separation device (8) and which is removably attached to the vacuum cleaner housing (2),
a removable filter (14) arranged in the airflow circuit (6), the removable filter (14) being housed in a filter chamber (15) of the handheld vacuum cleaner (1), the filter chamber (15) being formed at least in part in the vacuum cleaner housing (2) and being arranged at least in part between the suction unit (7) and a wall of the vacuum cleaner housing (2),
characterized in that
the filter chamber (15) comprises an access opening (15.1) for accessing the removable filter (14) that is formed in the handheld vacuum cleaner (1) such that the removable filter (14) can be accessed when the removable tank (9) has been detached from the vacuum cleaner housing (2) and in that, when the removable tank (9) is attached to the vacuum cleaner housing (2), the removable tank (9) is arranged relative to the vacuum cleaner housing (2) such that it prevents access to the removable filter (14) through the access opening (15.1).

2. The handheld vacuum cleaner (1) according to claim 1, in which the access opening (15.1) is formed in the vacuum cleaner housing (2) and is facing the removable tank (9) when the removable tank (9) is attached to the vacuum cleaner housing (2).

3. The handheld vacuum cleaner (1) according to claim 1, in which the intake head (4) forms a front part of the handheld vacuum cleaner (1), and in which the access opening (15.1) and the removable tank (9) are arranged relative to each other such that the removable filter (14) can be removed from the front of the handheld vacuum cleaner (1) through the access opening (15.1) when the removable tank (9) has been detached from the vacuum cleaner housing (2).

4. The handheld vacuum cleaner (1) according to any of claims 1 to 3, in which the filter chamber (15) is entirely contained within the vacuum cleaner housing (2) and is arranged between the suction unit (7) and a wall of the vacuum cleaner housing (2).

5. The handheld vacuum cleaner (1) according to any of claims 1 to 4, in which the removable filter (14) and the filter chamber (15) extend at least partially around the suction unit (7).

6. The handheld vacuum cleaner (1) according to claim 5, in which the removable filter (14) and the filter chamber (15) are generally annular in shape and extend around the suction unit (7), preferably around the electric motor (7.1) of the suction unit (7).

7. The handheld vacuum cleaner (1) according to any of claims 1 to 6, in which the electric motor (7.1) comprises an output shaft (7.3) with a rotary axis (X), in which the output shaft (7.3) is coupled to the fan (7.2), and in which the removable filter (14), the filter chamber (15) and the access opening (15.1) are annular in shape and are centered on the rotary axis (X).

8. The handheld vacuum cleaner (1) according to any of claims 1 to 7, in which the waste separation device (8), the fan (7.2) and the electric motor (7.1) are essentially aligned.

9. The handheld vacuum cleaner (1) according to claim 7, in which the waste separation device (8) is a cyclone separator with a main axis that is coaxial with the rotary axis (X) of the output shaft (7.3) of the electric motor (7.1).

10. The handheld vacuum cleaner (1) according to any of claims 1 to 9, in which the removable filter (14) is arranged in the airflow circuit (6) between the suction unit (7) and the exhaust port (5).

11. The handheld vacuum cleaner (1) according to any of claims 1 to 10, in which the handheld vacuum cleaner (1) comprises a suction unit casing (12) that at least partially surrounds the suction unit (7).

12. The handheld vacuum cleaner (1) according to claim 11, in which the suction unit casing (12) comprises a first wall (12.3) and a second wall (12.4) that are annularly shaped, for example tubular or frustoconical, the first annular wall (12.3) at least partially surrounding the suction unit (7) and the second annular wall (12.4) at least partially surrounding the first annular wall (12.3), the second annular wall (12.4) being concentric with the first annular wall (12.3) and being formed apart from the first annular wall (12.3) to define an annular space between the first annular wall (12.3) and the second annular wall (12.4), the annular space forming the filter chamber (15) in which the removable filter (14) is housed.

13. The handheld vacuum cleaner (1) according to claim 12, in which the second annular wall (12.4) of the suction unit casing (12) forms at least one wall of the vacuum cleaner housing (2.1, 2.2).

14. The handheld vacuum cleaner (1) according to claim 13, in which the second annular wall (12.4) comprises said at least one exhaust port (5), preferably several exhaust ports.

15. The handheld vacuum cleaner (1) according to any of claims 12 to 14, in which the first annular wall (12.3) and the second annular wall (12.4) are connected by at least one connecting wall (12.5) that extends radially, relative to the rotary axis (X) of the electric motor (7.1), between the first annular wall (12.3) and the second annular wall (12.4).

16. The handheld vacuum cleaner (1) according to claim 15, in which the connecting wall (12.5) extends to the bottom of the filter chamber (15), preferably on a side of the suction unit casing (12) that is opposite the access opening (15.1).

17. The handheld vacuum cleaner (1) according to any of claims 1 to 16, in which the removable filter (14) is annular in shape and preferably comprises a pleated filter medium (14.1) that is configured in an annular shape.

18. The handheld vacuum cleaner (1) according to claim 17, in which the removable filter (14) comprises annular end disks (14.2, 14.4) attached to the axial ends (14.3, 14.5) of the pleated filter medium (14.1).

19. The handheld vacuum cleaner (1) according to claim 18, in which a first annular end disk (14.2) closes the access opening (15.1) when the removable filter (14) is placed in the filter chamber (15).
